(19) United States
(12) Patent Application Publication
(10) Pub. No.: US 2026/0177021 A1
(43) Pub. Date: Jun. 25, 2026

(54) METHOD FOR CONTROLLING THE INJECTION OF COOLANT INTO AN INTERNAL COMBUSTION ENGINE OF A MOTOR VEHICLE AND RELATED VEHICLE AND COMPUTER PROGRAM PRODUCT

(71) Applicant: FERRARI S.P.A., Modena (MO) (IT)

(72) Inventors: Lorenzo TOMBARI, Modena (MO) (IT); Eugenio BARDI, Modena (MO) (IT); Barbara PRINA, Modena (MO) (IT); Luca VARISCO, Modena (MO) (IT)

(73) Assignee: FERRARI S.P.A., Modena (MO) (IT)

(21) Appl. No.: 19/421,065

(22) Filed: Dec. 16, 2025

(30) Foreign Application Priority Data
Dec. 19, 2024 (IT) 102024000029127

(51) Int. Cl. F02M 25/022; F02M 25/03

(52) U.S. Cl. CPC F02M 25/0227; F02M 25/03

(57) ABSTRACT

Method for controlling the injection of a coolant into a combustion chamber (of an internal combustion engine of a motor vehicle. The method comprises the steps of: acquiring at least one electrical signal, determining a corresponding quantity indicative of the rate of the combustion reaction within the internal combustion engine based on the acquired electrical signal associated with the operation of the injectors, verifying that the quantity indicative of the rate of the combustion reaction within the internal combustion engine meets a control criterion. If the quantity indicative of the rate of the combustion reaction within the engine meets the control criterion, performing first actions to control the injection of coolant into the combustion chamber. If the quantity indicative of the rate of the combustion reaction within the internal combustion engine does not meet the control criterion, performing second actions to control the injection of coolant into the combustion chamber.

### CROSS-REFERENCE TO RELATED APPLICATIONS

This patent application claims priority from Italian patent application no. 102024000029127 filed on Dec. 19, 2024, the entire disclosure of which is incorporated herein by reference.

### TECHNICAL FIELD

The invention generally relates to the sector of the propulsion of a motor vehicle, in particular with thermal propulsion, and more in particular to a method for controlling the injection of coolant into an internal combustion or thermal engine, in particular into a combustion chamber of the latter, of a motor vehicle, in particular with thermal propulsion, and to a related motor vehicle, as well as a related computer program product or software.

### PRIOR ART

As is known, the injection of coolant, for example water, into a combustion chamber of an internal combustion engine of a motor vehicle, in particular with thermal propulsion, allows controlling in an effective manner the temperature of the same internal combustion engine during the combustion reaction of the fuel, as well as controlling the rate of the same combustion reaction; in particular, the coolant is introduced in the form of spray or mixed with the fuel in order to cool the air/fuel mixture, increasing the resistance to the knock phenomena as well as related failures to the internal combustion engine.

A drawback connected to these aspects is that currently efficient and effective methods that allow monitoring the amount of coolant injected into the internal combustion engine of the motor vehicle are not known.

Therefore, the need is felt to deal with or eliminate the drawback set forth above.

An object of the invention is to meet the need set forth above, preferably in a simple and repeatable manner.

### DESCRIPTION OF THE INVENTION

The object is achieved by a method for controlling the injection of coolant into an internal combustion engine of a motor vehicle as defined in claim 1. The object is also achieved by a motor vehicle as defined in claim 11 and by a computer program product or software as defined in claim 12.

The dependent claims define particular embodiments of the invention.

### BRIEF DESCRIPTION OF THE DRAWINGS

In the following, an embodiment of the invention is described for a better understanding of the same by way of non-limiting example and with reference to the accompanying drawings wherein:

FIG. 1A schematically shows a motor vehicle according to the present invention;

FIG. 1B schematically shows at least a part of a combustion engine of the motor vehicle of FIG. 1A; and

FIG. 2 schematically shows a flow diagram of a method for controlling the injection of water into an internal combustion engine of the motor vehicle of FIG. 1 according to the present invention.

### EMBODIMENTS OF THE INVENTION

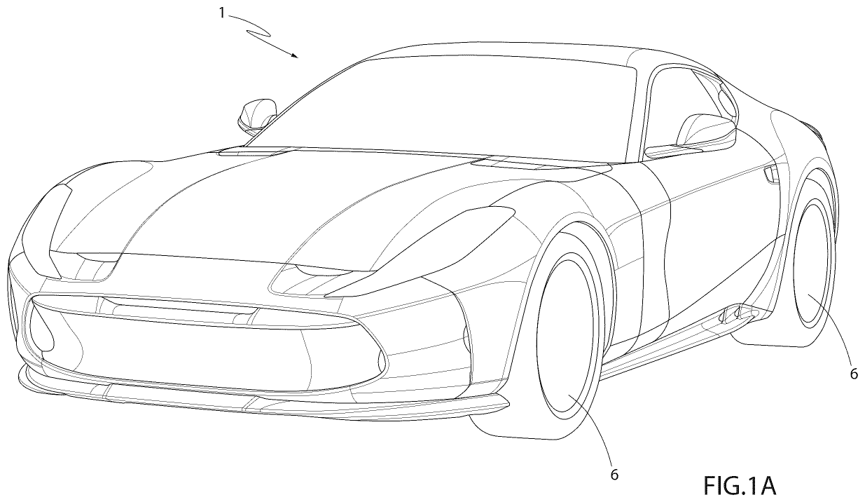

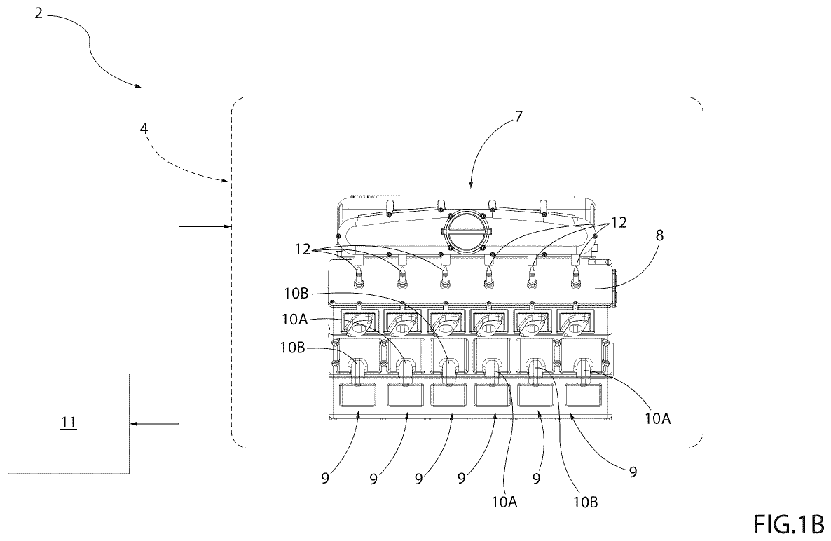

With joint reference to FIGS. 1A and 1B, in the following a motor vehicle 1 is described comprising a vehicular powertrain 2 (FIG. 1B); in particular, the powertrain 2 comprises a propulsion unit 4 and a transmission system (not shown) interposed between the propulsion unit 4 and drive wheels 6 of the motor vehicle 1. According to an aspect of the present invention, as schematically shown in FIG. 1B, the propulsion unit 4 comprises at least one internal combustion engine 7.

According to a further aspect of the present invention, not described in detail in the following, the propulsion unit 4 also comprises an electric motor or electric machine (not shown), namely the motor vehicle 1 is of the hybrid propulsion type. In the following, reference will be made, without thereby being limiting for the present invention, to a motor vehicle 1 with thermal propulsion, namely in which the propulsion unit 4 only comprises the internal combustion engine 7.

The internal combustion engine 7 also comprises a combustion chamber 8 designed to contain fuel, for example petrol, and to accommodate the combustion reaction for the operation of the motor vehicle 1; furthermore, the combustion chamber 8 is designed to contain a coolant, for example water or a mixture of water and ethanol, so as to control one or more parameters related to the combustion reaction of the fuel within the combustion chamber 8 (for example, to control the rate at which the combustion reaction occurs, in particular to slow it down).

The propulsion unit 4 also comprises at least one cylinder 9, in turn comprising at least a first and a second injector 10A, 10B configured to inject the fuel and the coolant, respectively, into the combustion chamber 8 or into an intake duct (not shown) of the internal combustion engine 7; according to an aspect of the present invention, by way of non-limiting example, the fuel is injected directly into the cylinders 9 and the coolant indirectly into the intake duct. Furthermore, the at least one cylinder 9 comprises at least one spark plug 12 designed to allow the combustion reaction to start in the combustion chamber 8 of the internal combustion engine 7.

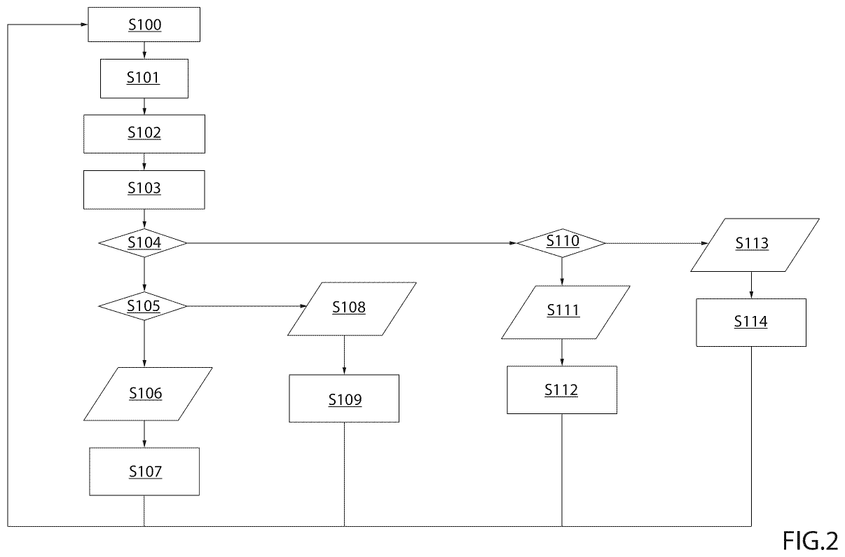

The motor vehicle 1 also comprises an electronic control unit (ECU) 11 connected to the propulsion unit 4 and configured to implement a method for controlling the injection of coolant into the combustion chamber 8 of the internal combustion engine 7 of the motor vehicle 1 as described in detail in the following with reference to FIG. 2. In particular, the electronic control unit 11 is designed to monitor and control the operation of the propulsion unit 4 during the operation of the motor vehicle 1, in particular during the running of the same.

The above-mentioned method for controlling the injection of coolant into the combustion chamber 8 of the internal combustion engine 7 of the motor vehicle 1 is now described with reference to FIG. 2.

In particular, the above-mentioned method comprises the steps of:
acquiring (block S100) at least one electrical signal SI₁, in particular at the at least one spark plug 12, and associated with the operation of the injectors 10A, 10B;
determining (block S101) a corresponding quantity indicative of the rate of the combustion reaction within the internal combustion engine 7 based on the acquired electrical signal SI₁;
verifying (blocks S102-S105, S110) that the quantity indicative of the rate of the combustion reaction within the internal combustion engine 7 meets a control criterion;
if the quantity indicative of the rate of the combustion reaction within the internal combustion engine 7 meets the control criterion, performing (blocks S106-S109) first actions to control the injection of coolant into the combustion chamber 8; and
if the quantity indicative of the rate of the combustion reaction within the internal combustion engine 7 does not meet the control criterion, performing (blocks S111-S114) second actions to control the injection of coolant into the combustion chamber 8.

According to an aspect of the present invention, the step of acquiring (block S100) the at least one electrical signal SI₁ comprises the step of acquiring at least one ionic signal SI₁ measured at respective electrical terminals (not shown) of the at least one spark plug 12. In particular, the electrical terminals are for example electrodes arranged at respective opposite ends of the at least one spark plug 12.

The step of determining (block S101) the quantity indicative of the rate of the combustion reaction within the internal combustion engine 7 comprises the step of determining (block S101) at least one flame front speed FFS₁ based on the at least one acquired electrical signal SI₁, in particular at the at least one spark plug 12.

In particular, the Applicant observes that the at least one flame front speed FFS₁ is defined as the tangent of a flame front angle and is indicative of the rate of the combustion reaction within the combustion chamber 8, in particular of the first steps of the combustion process of the fuel; consequently, the Applicant observed that the at least one flame front speed FFS₁ is an indicator of the rate of combustion of the fuel. In greater detail, as observed by the Applicant, in a motor vehicle with a traditional internal combustion engine, the rate of the combustion reaction in the combustion chamber 8 depends on several factors, in particular on the air/fuel ratio AR, also defined as λ, thereby defining a lean mixture within the combustion chamber 8; in the case of a motor vehicle with internal combustion engine injecting coolant, for example water or water-based fluids, as in the case of the motor vehicle 1 in FIG. 1, the injection of the above-mentioned coolant further affects the rate of the combustion reaction, in particular slowing it down in case of injection or accelerating it in case of failure in injecting. Consequently, in the case of the motor vehicle 1 in FIG. 1, the Applicant observed that the amount of coolant present in the combustion chamber 8 can be determined, according to the modes described in particular in the following, starting from the at least one flame front speed FFS₁, this being indicative of the rate of the combustion reaction, the latter affected precisely by the above-mentioned amount of coolant present in the combustion chamber 8 at the moment of the combustion reaction. It also follows that the electrical signal SI₁ acquired at SI₁ results to be a representation of the variation in the rate of the combustion reaction occurring in the combustion chamber 8.

According to an aspect of the present invention, as is also shown in FIG. 1, the propulsion unit 4 comprises further cylinders, similar to the at least one cylinder 9 and therefore indicated in the following by the same reference numeral; in particular, each cylinder 9 comprising respective further first and second injectors, the latter being similar to the at least first and second injectors 10A, 10B and therefore indicated in the following by the same reference numeral. Therefore, as is shown in FIG. 1B, by way of non-limiting example, the propulsion unit 4 comprises two main bearings of six cylinders 9, for a total of twelve cylinders 9, with respective twelve injectors 10A, 10B for a total of twenty-four, considering the fact that there are two main bearings of six cylinders 9. Furthermore, each further cylinder 9 comprises, in a manner similar to what is indicated in the foregoing, at least one respective further spark plug, each similar to the at least one spark plug 12 and therefore indicated by the same reference numeral; therefore, with reference to FIG. 1B, there are at least six spark plugs 12 per main bearing of cylinders 9.

The step of acquiring (block S100) at least one electrical signal SI₁ also comprises the step of acquiring further electrical signals SIᵢ (wherein i is an integer index greater than one and indicative of the numbering of each further injector 10A, 10B) in particular at the further spark plugs 12 and associated with the operation of the further injectors 10A, 10B; in particular, according to an aspect of the present invention, also the further electrical signals SIᵢ are ionic signals SIᵢ acquired at respective electrical terminals (not shown, for example respective pairs of electrodes opposite one another and therefore each arranged at respective ends of the respective further spark plugs 12). Consequently, the step of determining (block S101) at least one flame front speed FFS₁ also comprises the step of also determining respective further flame front speeds FFSᵢ based on the corresponding electrical signals SIᵢ.

Therefore, the step of verifying (blocks S102-S105) that the quantity indicative of the rate of the combustion reaction within the internal combustion engine 7 meets a control criterion comprises the steps of:
determining (block S102) an average flame front speed FFSₐᵥ based at least on the at least one determined flame front speed FFS₁ and conveniently based on the further determined flame speeds FFSᵢ;
verifying (blocks S103-S104) that the value of a flame front speed FFS₁, FFSᵢ of a corresponding cylinder 9 is greater than the value of the average flame front speed FFSₐᵥ; and
if the value of a flame front speed FFS₁, FFSᵢ is greater than the value of the average flame front speed FFSₐᵥ, verifying (block S105) that the value of such flame front speed FFS₁, FFSᵢ is much greater than the value of the average flame front speed FFSₐᵥ.

Therefore, as is also described in greater detail in the following, the flame front speed FFS₁, FFSᵢ of a respective cylinder 9 provides a relative indication with respect to the rate of combustion, to be compared with the flame front speed FFS₁, FFSᵢ of the remaining cylinders 9, namely it results to be an indicator of the relative type. In order to evaluate in an absolute manner the rate of the combustion reaction, as also described in the foregoing and in greater detail in the following, the flame front speed FFS₁, FFSᵢ of each cylinder 9 is to be compared with the value of the average flame front speed FFSₐᵥ, the latter being an average value and which allows providing an indication in absolute terms of the trend of the combustion reaction within the internal combustion engine 7.

Furthermore, the step of performing (blocks S106-S109) first actions to control the injection of coolant into the combustion chamber 8 of the internal combustion engine 7 of the motor vehicle 1 comprises the steps of:
if the value of such flame front speed FFS₁, FFSᵢ is much greater than the value of the average flame front speed FFSₐᵥ, determining (block S106) the occurrence of a possible failure in injecting coolant into the combustion chamber 8, in particular at least through the respective injector 10B; and
interrupting (block S107) the injection of fuel into the combustion chamber 8 if it is determined that a possible failure in injecting coolant into the combustion chamber 8 has occurred.

According to an aspect of the present invention, the step of verifying (blocks S102-S105) that the value of a flame front speed FFS₁, FFSᵢ is greater than the value of the average flame front speed FFSₐᵥ comprises the step of verifying (block S104) that the value of such flame front speed FFS₁, FFSᵢ assumes a value greater than the value of the average flame front speed FFSₐᵥ and within a first confidence interval IC₁ having as its lower boundary the value of the average flame front speed FFSₐᵥ. Furthermore, according to a further aspect of the present invention, the step of verifying (blocks S102-S105) that the value of such flame front speed FFS₁, FFSᵢ is much greater than the value of the average flame front speed FFSₐᵥ comprises the step of verifying (block S105) that the flame front speed FFS₁, FFSᵢ assumes a value greater than the value of the average flame front speed FFSₐᵥ and within a second confidence interval IC₂ having as its lower boundary the value of the average flame front speed FFSₐᵥ; in particular, the second confidence interval IC₂ has a greater extent than the first confidence interval IC₁. In this manner, it is possible to monitor the combustion reaction involving the fuel in the combustion chamber 8 and, based on how little coolant is present in the above-mentioned combustion chamber 8, to evaluate what actions are to be taken to avoid potential dangerous situations, for example knock phenomena. By way of example, according to an aspect of the present invention and without this limiting the same, the value of such flame front speed FFS₁, FFSᵢ is determined to be much greater than the value of the average flame front speed FFSₐᵥ if such value of flame front speed FFS₁, FFSᵢ is greater for example than 150% of the value of the average flame front speed FFSₐᵥ, namely the second confidence interval IC₂ is a set of values between the value of the average flame front speed FFSₐᵥ and a value equal to 150% of the value assumed by such of the average flame front speed FFSₐᵥ.

The step of performing (blocks S106-S109) first actions to control the injection of coolant into the combustion chamber 8 further comprises the steps of:
determining (block S108), if the value of such flame front speed FFS₁, FFSᵢ is not much greater than the value of the average flame front speed FFSₐᵥ, the presence of an amount of coolant injected into the combustion chamber 8 that is less than a corresponding threshold value FRₜₕ; and
increasing (block S109) the injection time of coolant into the combustion chamber 8 if it is determined that there is less coolant than the corresponding threshold value FRₜₕ.

The step of verifying (blocks S102-S105, S110-S111) that the quantity indicative of the rate of the combustion reaction within the internal combustion engine 7 meets a control criterion also comprises the step of verifying (block S110) that the value of a corresponding flame front speed FFS₁, FFSᵢ is less than the value of average flame front speed FFSₐᵥ.

Consequently, the step of performing (blocks S111-S114) second actions to control the injection of coolant into the combustion chamber 8 comprises the steps of:
if the value of such flame front speed FFS₁, FFSᵢ is lower than the value of average flame front speed FFSₐᵥ, determining (block S111) the presence of an amount of coolant injected into the combustion chamber 8 higher than the corresponding threshold value FRₜₕ; and
reducing (block S112) the injection time of coolant into the combustion chamber 8 if it is determined that there is more coolant than a corresponding threshold value FRₜₕ.

The step of performing (blocks S111-S114) second actions to control the injection of coolant into the combustion chamber 8 also comprises the steps of:
if the value of such flame front speed FFS₁, FFSᵢ is greater than or equal to the value of average flame front speed FFSₐᵥ, determining (block S113) that the amount of coolant injected into the combustion chamber 8 is optimal; and
maintaining (block S114) the value of injection time of coolant into the combustion chamber 8 set if it is determined that the amount of coolant injected into the combustion chamber 8 is optimal.

In greater detail, according to an aspect of the present invention, the step of determining (block S113) that the amount of coolant injected into the combustion chamber 8 of the internal combustion engine 7 is optimal comprises the step of determining (block S114) that the amount of coolant injected into the combustion chamber 8 of the internal combustion engine 7 is such that the value of such flame front speed FFS₁, FFSᵢ is equal to a predefined value FFS_{cal}, the latter being defined during the step of calibrating the internal combustion engine 7 during the development of the same.

At the end of the performance of any one of the above-mentioned first and second actions, the method comprises the step of repeating the steps S100-S114 for the subsequent combustion reaction that occurs in the combustion chamber 8.

The present invention also relates to a computer program product or software loadable and executable by an electronic control unit 11 of the motor vehicle 1; in particular, the software comprises instructions which, when the software is executed by the electronic control unit 11, cause the electronic control unit 11 to execute the control method described in the previous paragraphs of the present description.

Based on the foregoing, the advantages of the present method and of the related motor vehicle 1, as well as of the related computer program product, are evident.

In particular, the present invention allows monitoring accurately and in closed loop the amount of coolant, in particular water or similar water-based fluids, in the combustion chamber 8 of the motor vehicle 1, with consequent possibility to act in the case where it is determined that there is more or less coolant than a threshold value representative of the optimal condition of operation of the internal combustion engine 7. Such advantage allows having a greater stability for the combustion reaction within the combustion chamber 8, since the present invention allows the monitoring and the management thereof in case of detection of conditions distant from the optimal. Furthermore, the present invention also allows managing in an efficient manner the amount of coolant available, thus avoiding waste of the same.

Additionally, the present invention allows improving the reliability of the internal combustion engine 7 of the motor vehicle 1, avoiding or at least limiting the need to make dry runs to verify that the internal combustion engine 7 operates correctly.

Finally, it is clear that modifications and variations can be made to the motor vehicle 1 according to the invention which anyway do not depart from the scope of protection defined by the claims.

In particular, the number and the shape of each of the described and illustrated components could be different.

Furthermore, the various illustrated embodiments can be combined with one another without any limitations, with particular reference to the various characteristics individually described in the various paragraphs of the description. Each of such characteristics is independently applicable to each of the described embodiments.

What is claimed is:

1. Method for controlling the injection of a coolant into a combustion chamber of an internal combustion engine of a motor vehicle;
the motor vehicle comprises a vehicular powertrain comprising a propulsion unit and a transmission system interposed between the propulsion unit and drive wheels of the motor vehicle, the propulsion unit comprising at least the internal combustion engine;
the propulsion unit comprising at least one cylinder comprising at least a first and a second injector configured to inject fuel and the coolant, respectively, into the combustion chamber or into an intake duct of the internal combustion engine;
the method comprising the steps of:
acquiring at least one electrical signal associated with the operation of the injectors;
determining a corresponding quantity indicative of the rate of the combustion reaction within the internal combustion engine based on the acquired electrical signal;
verifying that the quantity indicative of the rate of the combustion reaction within the internal combustion engine meets a control criterion;
if the quantity indicative of the rate of the combustion reaction within the internal combustion engine meets the control criterion, performing first actions to control the injection of coolant into the combustion chamber; and
if the quantity indicative of the rate of the combustion reaction within the internal combustion engine does not meet the control criterion, performing second actions to control the injection of coolant into the combustion chamber.

2. The control method according to claim 1, wherein the step of determining the quantity indicative of the rate of the combustion reaction within the internal combustion engine comprises the step of determining at least one flame front speed based on the at least one acquired electrical signal.

3. The control method according to claim 2, wherein the propulsion unit comprises further cylinders, each cylinder comprising respective further first and second injectors configured to inject fuel and the coolant, respectively, into the combustion chamber or into the intake duct of the internal combustion engine;
wherein the step of acquiring at least one electrical signal also comprises the step of acquiring further electrical signals associated with the operation of the further injectors;
wherein the step of determining at least one flame front speed comprises the step of determining respective further flame front speeds based on corresponding electrical signals;
wherein the step of verifying that the quantity indicative of the rate of the combustion reaction within the internal combustion engine meets a control criterion comprises the steps of:
determining an average flame front speed based on the at least one determined flame front speed and on the further determined flame front speeds;
verifying that the value of a flame front speed is greater than the value of the average flame front speed;
if the value of a flame front speed is greater than the value of the average flame front speed, verifying that the value of such flame front speed is much greater than the value of the average flame front speed; and
wherein the step of performing first actions to control the injection of coolant into the combustion chamber comprises the steps of:
if the value of such flame front speed is much greater than the value of the average flame front speed, determining the occurrence of a possible failure in injecting coolant into the combustion chamber; and
interrupting the injection of fuel into the combustion chamber if it is determined that a possible failure in injecting coolant into the combustion chamber has occurred.

4. The control method according to claim 3, wherein the step of verifying that the value of a flame front speed is greater than the value of the average flame front speed comprises the step of verifying that the value of such flame front speed assumes a value greater than the value of the average flame front speed and within a first confidence interval having as its lower boundary the value of the average flame front speed.

5. The control method according to claim 4, wherein the step of verifying that the value of such flame front speed is much greater than the value of the average flame front speed comprises the step of verifying that the flame front speed assumes a value greater than the value of the average flame front speed and within a second confidence interval having as its lower boundary the value of the average flame front speed, the second confidence interval having a greater extent than the first confidence interval.

6. The control method according to claim 3, wherein the step of performing first actions to control the injection of coolant into the combustion chamber comprises the steps of:
determining, if the value of such flame front speed is not much greater than the value of the average flame front speed, the presence of an amount of coolant injected into the combustion chamber that is less than a corresponding threshold value; and increasing the injection time of coolant into the combustion chamber if it is determined that there is less coolant than the corresponding threshold value.

7. The control method according to claim 6, wherein the step of verifying) that the quantity indicative of the rate of the combustion reaction within the internal combustion engine meets a control criterion also comprises the step of verifying that the value of a corresponding flame front speed is less than the value of average flame front speed; and
wherein the step of performing second actions to control the injection of coolant into the combustion chamber comprises the steps of:
if the value of such flame front speed is lower than the value of average flame front speed, determining the presence of an amount of coolant injected into the combustion chamber higher than the threshold value; and
reducing the injection time of coolant into the combustion chamber if it is determined that there is more coolant than the threshold value.

8. The control method according to claim 7, wherein the step of performing second actions to control the injection of coolant into the combustion chamber comprises the steps of:
if the value of such flame front speed is greater than or equal to the value of average flame front speed, determining that the amount of coolant injected into the combustion chamber is optimal; and
maintaining the value of injection time of coolant into the combustion chamber set if it is determined that the amount of coolant injected into the combustion chamber is optimal.

9. The control method according to claim 8, wherein the step of determining that the amount of coolant injected into the combustion chamber is optimal comprises the step of determining that the amount of coolant injected into the combustion chamber of the internal combustion engine is such that the value of such flame front speed is equal to a predefined value.

10. The control method according to claim 1, wherein the step of acquiring at least one electrical signal comprises the step of acquiring at least one ionic signal measured at respective electrical terminals of at least one spark plug of the corresponding at least one cylinder.

11. A motor vehicle comprising a vehicular powertrain comprising a propulsion unit and a transmission system interposed between the propulsion unit and drive wheels of the motor vehicle, the propulsion unit comprising at least one internal combustion engine;
the propulsion unit comprising at least one cylinder comprising at least a first and a second injector configured to inject fuel and the coolant, respectively, into the combustion chamber or into an intake duct of the internal combustion engine;
the motor vehicle also comprising an electronic control unit connected to the propulsion unit and configured to implement a method for controlling the injection of coolant into the combustion chamber in the internal combustion engine of the motor vehicle according to claim 1.

12. Computer program product loadable in and executable by an electronic control unit of a motor vehicle according to claim 11, the computer program product comprising instructions which, when the computer program product is executed by the electronic control unit, cause the electronic control unit to execute a method for controlling the injection of coolant into a combustion chamber of an internal combustion engine of the motor vehicle according to claim 1.
